(19) United States
(12) Patent Application Publication
(10) Pub. No.: US 2011/0242808 A1
(43) Pub. Date: Oct. 6, 2011

(54) Lighting Device Having Enhanced Brightness

(76) Inventor: Ming-Tsai Wang, Dailiao Township (TW)

(21) Appl. No.: 12/754,835

(22) Filed: Apr. 6, 2010

(51) Int. Cl. F21V 1/00; F21S 4/00

(52) U.S. Cl. 362/235; 362/249.01; 362/249.02; 362/373

(57) ABSTRACT

A lighting device includes a main body, a plurality of light emitting members mounted in the main body, a heat radiating unit mounted on the main body to provide a heat radiating effect to the light emitting members, and a lens mounted on the main body to regulate a light emitting effect of the light emitting members. The lens includes a plurality of arcuate faces having different curvatures. Thus, the light emitting members co-operate with the arcuate faces of the lens to enhance the brightness and lighting efficiency of the light emitting members and to save the electric energy. In addition, the heat radiating unit prevents concentration of a heat radiation by arrangement of the upright heat radiating fins and the inclined heat radiating fins to enhance the heat radiating effect of the heat radiating unit.

### BACKGROUND OF THE INVENTION

1. Field of the Invention

The present invention relates to a lighting device and, more particularly, to a lighting device to provide a lighting effect.

2. Description of the Related Art

A conventional lighting device comprises a plurality of light emitting diodes to provide a lighting effect. However, each of the light emitting diodes has a smaller brightness so that the lighting device needs to provide a larger number of light emitting diodes so as to enhance the brightness of the lighting device, thereby increasing the costs of fabrication. In addition, the light emitting diodes easily produce a greater heat and a concentration of heat radiation, thereby decreasing the working efficiency of the lighting device.

### BRIEF SUMMARY OF THE INVENTION

In accordance with the present invention, there is provided a lighting device, comprising a main body, a plurality of light emitting members mounted in the main body, and a heat radiating unit mounted on the main body to provide a heat radiating effect to the light emitting members. The lighting device further comprises a lens mounted on the main body to regulate a light emitting effect of the light emitting members. The lens includes a plurality of arcuate faces having different curvatures.

The primary objective of the present invention is to provide a lighting device having an enhanced brightness.

Another objective of the present invention is to provide a lighting device that saves the electric power.

A further objective of the present invention is to provide a lighting device having a greater heat radiating effect.

A further objective of the present invention is to provide a lighting device, wherein the light emitting members co-operate with the arcuate faces of the lens to enhance the brightness and lighting efficiency of the light emitting members and to save the electric energy.

A further objective of the present invention is to provide a lighting device, wherein the heat radiating unit can prevent concentration of a heat radiation by arrangement of the upright heat radiating fins and the inclined heat radiating fins so as to enhance the heat radiating effect of the heat radiating unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lighting device in accordance with the preferred embodiment of the present invention.

FIG. 2 is a front view of the lighting device as shown in FIG. 1.

FIG. 3 is a top view of the lighting device as shown in FIG. 1.

FIG. 4 is a cross-sectional view of the lighting device taken along line 4-4 as shown in FIG. 3.

FIG. 5 is a bottom view of the lighting device as shown in FIG. 1.

FIG. 6 is a side view of the lighting device as shown in FIG. 5.

FIGS. 7-10 are front views of a light emitting member of the lighting device as shown in FIG. 1.

### DETAILED DESCRIPTION OF THE INVENTION

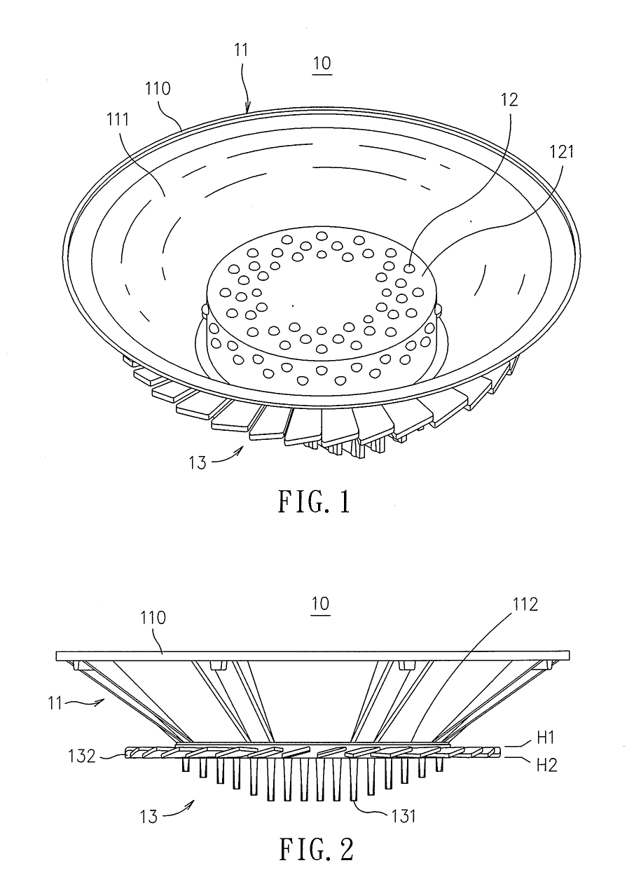

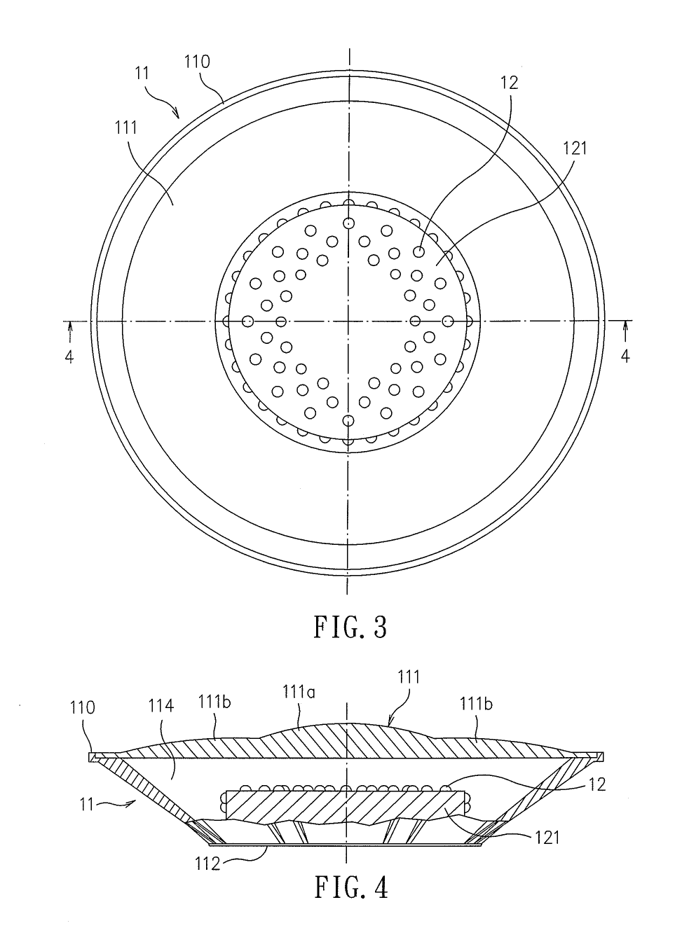

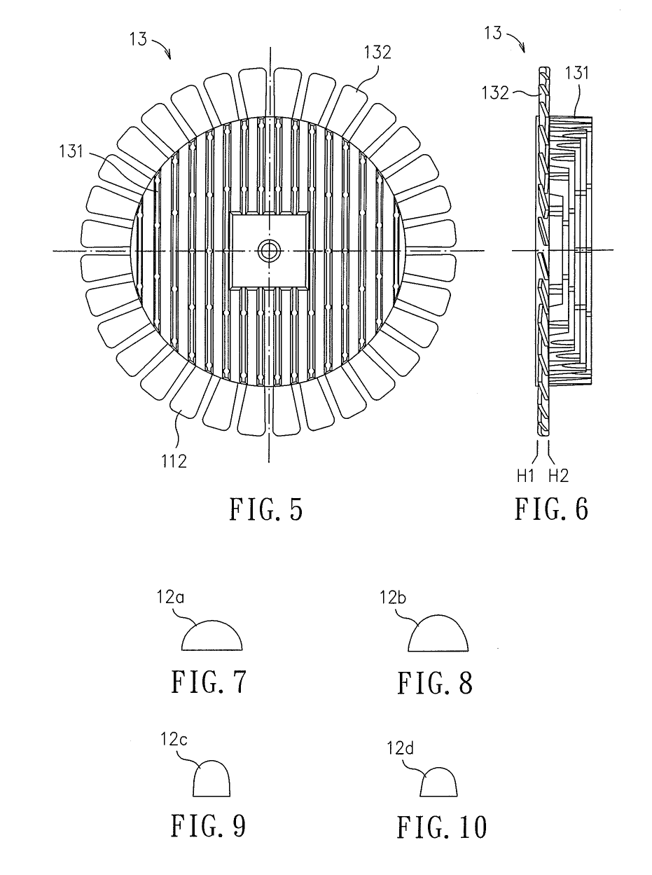

Referring to the drawings and initially to FIGS. 1-6, a lighting device 10 in accordance with the preferred embodiment of the present invention comprises a main body 11, a plurality of light emitting members 12 mounted in the main body 11, a holder 121 mounted in the main body 11 to hold the light emitting members 12, a control circuit (not shown) electrically connected to the light emitting members 12 to actuate and control operation of the light emitting members 12, a lens 111 mounted on the main body 11 to regulate a light emitting effect of the light emitting members 12, and a heat radiating unit 13 mounted on the main body 11 to provide a heat radiating effect to the light emitting members 12.

The main body 11 has a solid first side 112 and an open second side 110. The main body 11 has a funnel shape and has a diameter gradually increased from the first side 112 toward the second side 110 of the main body 11. The main body 11 has an inside provided with a receiving chamber 114 to receive the light emitting members 12. The receiving chamber 114 of the main body 11 is located between the first side 112 and the second side 110 of the main body 11.

The lens 111 is mounted on the second side 110 of the main body 11. The lens 111 is made of a light permeable material, such as a transparent glass or plastic material. The lens 111 includes a plurality of arcuate faces 111a and 111b having different curvatures. The curvatures of the arcuate faces 111a and 111b of the lens 111 are determined according to the size of the main body 11 and the number and the brightness of the light emitting members 12. Each of the arcuate faces 111a and 111b of the lens 111 is a convex face and protrudes outwardly from the second side 110 of the main body 11. Thus, the light beams emitted from the light emitting members 12 pass through and are refracted by the arcuate faces 111a and 111b of the lens 111. Then, the light beams are projected outwardly from the lens 111.

The light emitting members 12 and the holder 121 are received in the receiving chamber 114 of the main body 11 and are located between the first side 112 and the second side 110 of the main body 11. The light emitting members 12 and the holder 121 are mounted on the first side 112 of the main body 11. Each of the light emitting members 12 is made of a light emitting diode. The light emitting members 12 are arranged on the holder 121 in an annular manner. Thus, the light emitting members 12 co-operate with the arcuate faces 111a and 111b of the lens 111 to enhance the brightness and lighting efficiency of the light emitting members 12 and to save the electric energy.

The heat radiating unit 13 is mounted on the first side 112 of the main body 11 so that the first side 112 of the main body 11 is sandwiched between the heat radiating unit 13 and the light emitting members 12. The heat radiating unit 13 includes a plurality of upright heat radiating fins 131 and a plurality of inclined heat radiating fins 132. Each of the upright heat radiating fins 131 of the heat radiating unit 13 has a substantially flat rectangular shape. The upright heat radiating fins 131 of the heat radiating unit 13 are parallel with each other and extend outwardly from the first side 112 of the main body 11. The upright heat radiating fins 131 of the heat radiating unit 13 have different lengths, and the lengths of the upright heat radiating fins 131 are decreased gradually from a middle position toward two opposite ends of the first side 112 of the main body 11. The inclined heat radiating fins 132 of the heat radiating unit 13 surround the upright heat radiating fins 131 of the heat radiating unit 13 in an annular manner and extend radially and outwardly from a central portion of the first side 112 of the main body 11. Each of the inclined heat radiating fins 132 of the heat radiating unit 13 is inclined relative to each of the upright heat radiating fins 131 of the heat radiating unit 13. Each of the inclined heat radiating fins 132 of the heat radiating unit 13 extends outwardly in an inclined manner from a first axial length “H1” toward a second axial length “H2” of each of the upright heat radiating fins 131 of the heat radiating unit 13. Thus, the heat radiating unit 13 can prevent concentration of a heat radiation by arrangement of the upright heat radiating fins 131 and the inclined heat radiating fins 132 so as to enhance the heat radiating effect of the heat radiating unit 13.

As shown in FIGS. 7-10, each of the light emitting members 12a, 12b, 12c and 12d has a substantially arc-shaped outer surface and has different curvatures. Thus, the light emitting members 12a, 12b, 12c and 12d co-operate with the arcuate faces 111a and 111b of the lens 111 to enhance the lighting efficiency of the light emitting members 12a, 12b, 12c and 12d.

Accordingly, the light emitting members 12 co-operate with the arcuate faces 111a and 111b of the lens 111 to enhance the brightness and lighting efficiency of the light emitting members 12 and to save the electric energy. In addition, the heat radiating unit 13 can prevent concentration of a heat radiation by arrangement of the upright heat radiating fins 131 and the inclined heat radiating fins 132 so as to enhance the heat radiating effect of the heat radiating unit 13.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lighting device, comprising:
a main body;
a plurality of light emitting members mounted in the main body;
a heat radiating unit mounted on the main body to provide a heat radiating effect to the light emitting members.

2. The lighting device of claim 1, further comprising:
a lens mounted on the main body to regulate a light emitting effect of the light emitting members.

3. The lighting device of claim 2, wherein
the main body has a solid first side and an open second side;
the heat radiating unit is mounted on the first side of the main body;
the lens is mounted on the second side of the main body.

4. The lighting device of claim 3, wherein
the lens includes a plurality of arcuate faces having different curvatures;
the light emitting members co-operate with the arcuate faces of the lens.

5. The lighting device of claim 4, wherein the curvatures of the arcuate faces of the lens are determined according to the size of the main body and the number and the brightness of the light emitting members.

6. The lighting device of claim 4, wherein each of the arcuate faces of the lens is a convex face.

7. The lighting device of claim 4, wherein each of the arcuate faces of the lens protrudes outwardly from the second side of the main body.

8. The lighting device of claim 1, wherein the heat radiating unit includes a plurality of upright heat radiating fins and a plurality of inclined heat radiating fins.

9. The lighting device of claim 8, wherein each of the upright heat radiating fins of the heat radiating unit has a substantially flat rectangular shape.

10. The lighting device of claim 8, wherein
the upright heat radiating fins of the heat radiating unit are parallel with each other;
the upright heat radiating fins of the heat radiating unit extend outwardly from the first side of the main body.

11. The lighting device of claim 8, wherein
the upright heat radiating fins of the heat radiating unit have different lengths;
the lengths of the upright heat radiating fins are decreased gradually from a middle position toward two opposite ends of the first side of the main body.

12. The lighting device of claim 8, wherein
the inclined heat radiating fins of the heat radiating unit surround the upright heat radiating fins of the heat radiating unit in an annular manner;
the inclined heat radiating fins of the heat radiating unit extend radially and outwardly from a central portion of the first side of the main body.

13. The lighting device of claim 1, wherein
each of the inclined heat radiating fins of the heat radiating unit is inclined relative to each of the upright heat radiating fins of the heat radiating unit;
each of the inclined heat radiating fins of the heat radiating unit extends outwardly in an inclined manner from a first axial length toward a second axial length of each of the upright heat radiating fins of the heat radiating unit.

14. The lighting device of claim 1, wherein
each of the light emitting members has a substantially arc-shaped outer surface;
each of the light emitting members has different curvatures.

15. The lighting device of claim 3, further comprising:
a holder mounted in the main body to hold the light emitting members.

16. The lighting device of claim 15, wherein
the light emitting members and the holder are mounted on the first side of the main body;
the light emitting members are arranged on the holder in an annular manner.

17. The lighting device of claim 1, wherein each of the light emitting members is made of a light emitting diode.

18. The lighting device of claim 16, wherein the first side of the main body is sandwiched between the heat radiating unit and the light emitting members.

19. The lighting device of claim 3, wherein
the main body has a funnel shape and has a diameter gradually increased from the first side toward the second side of the main body;
the lens is made of a light permeable material.

20. The lighting device of claim 15, wherein
the main body has an inside provided with a receiving chamber to receive the light emitting members;
the receiving chamber of the main body is located between the first side and the second side of the main body;
the light emitting members and the holder are received in the receiving chamber of the main body and are located between the first side and the second side of the main body.
